(19) United States
(12) Patent Application Publication
(10) Pub. No.: US 2026/0154947 A1
(43) Pub. Date: Jun. 4, 2026

(54) METHOD AND DEVICE FOR ACQUIRING TRAINING DATA FOR INFERENCE MODEL

(71) Applicants: Hyundai Motor Company, Seoul (KR); Kia Corporation, Seoul (KR)

(72) Inventor: Hyeong Gyu KIM, Hwaseong-Si (KR)

(21) Appl. No.: 19/356,658

(22) Filed: Oct. 13, 2025

(30) Foreign Application Priority Data
Dec. 2, 2024 (KR) 10-2024-0176329

(51) Int. Cl. G06V 10/774; G06V 10/74; G06V 20/56

(52) U.S. Cl. CPC G06V 10/774; G06V 10/761; G06V 20/56

(57) ABSTRACT

Disclosed herein a method and device for acquiring training data for inference model. The method includes: identifying a state indicator indicating whether there is a similarity between preceding selected image data and previously acquired image data subsequent to the selected image data based on acquisition of image data around the device; generating a similarity between the preceding selected image data and the acquired image data based on presence of a similarity in the state indicator; generating selected evaluation data including a score of the acquired image data according to an evaluation using acquired feature information of the acquired image data based on determining that the similarity exceeds a first reference value; and/or selecting the acquired image data as the selected image data for the training data to replace the preceding selected image data based on determining that the score of the acquired image data exceeds the score of the preceding selected image data.

### CROSS-REFERENCE TO RELATED APPLICATION

This application claims priority to and the benefit of Korean Patent Application No. 10-2024-0176329, filed on December 2, 2024, the disclosure of which is incorporated herein by reference in its entirety.

### BACKGROUND

### Field

The present disclosure relates to a method and device for acquiring training data for an inference model, and more particularly, to a method and device for acquiring training data that improves acquisition efficiency of acquiring high-quality training data by selecting data that is valid for training an inference model while preventing collection of redundant data.

### Discussion of Related Art

Vehicles may be equipped with autonomous driving functions for driver convenience. The autonomous driving functions are being improved to realize fully autonomous driving, where a vehicle completely controls driving without driver intervention in any situation. Before the transition to fully autonomous driving, some functions of fully autonomous driving are being installed and utilized in commercialized vehicles.

An autonomous driving vehicle may perceive its surrounding environment through sensors, acquire various data from both inside and outside the vehicle, identify situations around the vehicle based on the perceived environment and data, establish an autonomous driving strategy or control plan corresponding to the identified situation, and/or control the vehicle’s actuators for driving according to the strategy.

A driving support model for autonomous driving may be installed in the vehicle and/or installed in a server that controls the vehicle, and may be an inference model based on training (e.g., training of an artificial neural network, manual testing, or the like). Recently, it has become possible to build an inference model as an artificial intelligence network. The inference model may be trained in advance and implemented, and may be re-trained by collecting data for additional training of the model during the execution of the model. This may be referred to as active learning. In active learning, training data may be selected from a collected random dataset, the selected training data may be labeled, and a process of training again using the labeled training data may be repeated, thereby improving network inference performance.

The training data may be image data, and the selection of the image data may be executed at a fixed time period and/or a fixed frame period. In the case of the selection according to the fixed period, if the selection execution period is short, problems may arise: for example, the image data with scenes similar to those of the already acquired image data may be excessively selected, and the image data for training may be collected redundantly. The collection of the redundant training data may hinder the diversity of the training data and adversely affect the performance of the inference model. There are also problems that arise if the execution period is long: for example, image data with important scenes that are significant for training may be omitted.

### SUMMARY

The present disclosure may be directed to providing a method and device for acquiring training data for an inference model, which may improve an acquisition efficiency of high-quality training data by, for example, preventing the collection of redundant data and instead selecting data that is valid for training an inference model.

The technical problems of the present disclosure are not limited to the above-described technical problems. That is, other technical problems that are not described may be obviously understood by those skilled in the art to which the present disclosure pertains from the following description.

Aspects described herein may provide a method of acquiring training data for an inference model, the method comprising: identifying a state indicator indicating whether there is a similarity between preceding selected image data and previously acquired image data subsequent to the selected image data based on acquisition of image data around the device according to a selection cycle; generating a similarity between the preceding selected image data and the acquired image data based on presence of a similarity in the state indicator; generating selected evaluation data including a score of the acquired image data according to an evaluation using acquired feature information of the acquired image data based on determining that the similarity is greater than or equal to a first reference value; and/or selecting the acquired image data as the selected image data for the training data to replace the preceding selected image data based on determining that the score of the acquired image data exceeds the score of the preceding selected image data.

The acquired feature information may include at least one of entropy data related to the inference uncertainty probability of the acquired image data generated by the inference model and vector data resulting from the abstraction of the acquired image data.

The preceding selected image data may be preliminarily selected and temporarily stored, or be continuously stored and managed as finally selected image data.

Prior to selecting the acquired image data, the method may further include determining whether the score of the acquired image data exceeds a second reference value, and the selecting of the acquired image data is performed in response to the score of the acquired image data exceeding the second reference value.

After identifying the state indicator, the method may further include generating the selected evaluation data including the score of the acquired image data according to the evaluation based on absence of the similarity in the state indicator; changing the state indicator so that the state indicator indicates presence of the similarity based on the score of the selected evaluation data exceeding a second reference value; and selecting the acquired image data as the selected image data.

The selected acquired image data may be preliminarily adopted as the selected image data and temporarily stored.

After generating the similarity, the method may further include changing the state indicator to indicate absence of the similarity based on determining that the similarity is less than the first reference value; and/or may include determining the preceding selected image data as finally selected image data and continuously storing the determined preceding selected image data.

After selecting the acquired image data, the method may further include transmitting the acquired image data determined as finally selected image data to an external device.

The transmitting of the acquired image data to the external device may be performed in response to at least one termination event of deactivation of the inference model, selection processing of the acquired image data, and/or a non-operational state (e.g., an operation off) of the device. The acquired image data may be continuously stored in response to the termination event, and the device embeds the inference model.

After generating the selected evaluation data, the method may further include generating selected evaluation data including the score of the acquired image data according to the evaluation based on acquisition of subsequently acquired image data according to the selection cycle based on determining that the score of the acquired image data is lower than or equal to the score of the preceding selected image data; determining whether the score of the subsequently acquired image data exceeds the score of the preceding selected image data; and/or determining whether to select the subsequently acquired image data as the selected image data to replace the preceding selected image data based on the determination.

Aspects described herein further relate to a device for acquiring training data for an inference model, the device comprising one or more of: a sensor unit configured to detect a surrounding environment; a transceiver configured to transmit and receiving data to and from an external device; a memory configured to store at least one instruction; and at least one processor configured to execute the at least one instruction stored in the memory. The at least one processor may be configured to: identify a state indicator indicating whether there is a similarity between preceding selected image data and previously acquired image data subsequent to the selected image data based on acquisition of image data around the device from the sensor unit according to a selection cycle, generate a similarity between the preceding selected image data and the acquired image data based on presence of a similarity in the state indicator, generate selected evaluation data including a score of the acquired image data according to an evaluation using acquired feature information of the acquired image data based on determining that the similarity is greater than or equal to a first reference value, and/or select the acquired image data as the selected image data for the training data to replace the preceding selected image data based on determining that the score of the acquired image data exceeds the score of the preceding selected image data.

The features briefly summarized above for this disclosure are only illustrative aspects of the detailed description of the disclosure which follow, and are not intended to limit the scope of the disclosure.

### BRIEF DESCRIPTION OF THE DRAWINGS

The above and other objects, features and advantages of the present invention will become more apparent by describing examples thereof in detail with reference to the accompanying drawings, in which:

FIG. 1 is a diagram illustrating a vehicle communicating with another device to transmit and receive data;

FIG. 2 is a diagram illustrating a module constituting a vehicle;

FIG. 3 is a diagram illustrating a module constituting a server;

FIGS. 4A and 4B are flowcharts of a method for acquiring training data of an inference model;

FIG. 5 is a diagram illustrating a training-based inference model;

FIG. 6 is a diagram illustrating a process of acquiring training data; and

FIG. 7 is a flowchart illustrating a process of terminating selection of image data and transmitting the image data in the method for acquiring training data of an inference model.

### DETAILED DESCRIPTION

Hereinafter, examples of the present disclosure will be described in detail with reference to the accompanying drawings. However, the present disclosure may be implemented in various different ways, and is not limited to the examples described therein.

In describing examples of the present disclosure, the same constituent elements in the drawings are denoted by the same reference numerals, and a repeated description of the same elements will be omitted.

In the present disclosure, when an element is simply referred to as being “connected to,” “coupled to,” and/or “linked to” another element, this may mean that an element is “directly connected to,” “directly coupled to,” and/or “directly linked to” another element or is connected to, coupled to or linked to another element with the other element intervening therebetween. In addition, when an element “includes” and/or “has” another element, this means that one element may further include another element without excluding another component unless specifically stated otherwise.

In the present disclosure, the terms first, second, etc. are used to distinguish one element from another and do not limit the order or the degree of importance between the elements unless specifically mentioned. Accordingly, a first element in an example could be termed a second element in another example, and, similarly, a second element in an example could be termed a first element in another example.

In the present disclosure, elements that are distinguished from each other are for clearly describing each feature, and do not necessarily mean that the elements are separated. That is, a plurality of elements may be integrated in one hardware or software unit, or one element may be distributed and formed in a plurality of hardware or software units. Therefore, even if not mentioned otherwise, such integrated or distributed examples are included in the scope of the present disclosure.

In the present disclosure, elements described in various examples do not necessarily mean essential elements, and some of them may be optional elements. Therefore, an example composed of a subset of elements described in an example is also included in the scope of the present disclosure. In addition, examples including other elements in addition to the elements described in the various examples are also included in the scope of the present disclosure.

The advantages and features of the present invention and the way of attaining them will become apparent with reference to examples described below in detail in conjunction with the accompanying drawings. Examples, however, may be embodied in many different forms and should not be constructed as being limited to examples set forth herein. Rather, these examples are provided so that this disclosure will be complete and will fully convey the scope of the invention to those skilled in the art.

In the present disclosure, each of phrases such as "A or B," "at least one of A and B," "at least one of A or B," "A, B or C," "at least one of A, B and C," may include any one or all possible combinations of the items listed together in the corresponding one of the phrases. For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as "A, B, or C", "at least one of A, B, and C", "at least one of A, B, or C", etc. as used herein may mean each listed item or all possible combinations of the listed items. For example, "at least one of A or B" may refer to (1) at least one A; (2) at least one B; or (3) at least one A and at least one B.

In the present disclosure, expressions of location relations used in the present specification such as “upper,” “lower,” “left,” and “right” are employed for the convenience of explanation, and in case drawings illustrated in the present specification are inversed, the location relations described in the specification may be inversely understood.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be activated based on configured autonomous driving control setting(s) (e.g., based on at least one of: an autonomous driving classification, a selection of an autonomous driving level for a vehicle, etc.). Based on one or more features (e.g., features of the value indicating a similarity, the similarity value, the score, etc.) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., features of the value indicating a similarity, the similarity value, the score, etc.) described herein.

One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., features of the value indicating a similarity, the similarity value, the score, etc.) described herein.

Minimum risk maneuver (MRM) operation(s) may also be controlled, for example, based on one or more features (e.g., features of the value indicating a similarity, the similarity value, the score, etc.) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., features of the value indicating a similarity, the similarity value, the score, etc.) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane. The driving control apparatus may identify or determine a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., features of the value indicating a similarity, the similarity value, the score, etc.) described herein. An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.).

An autonomous driving level and/or autonomous driving activation/deactivation may also be controlled, for example, based on one or more features (e.g., features of the value indicating a similarity, the similarity value, the score, etc.) described herein. A driving control apparatus may perform an autonomous driving level control (e.g., a change of an autonomous driving level, a change of a required user attentiveness, etc.) or cause deactivation of an autonomous driving operation. For example, by changing the required user attentiveness, the driver may be required to place his/her hands on the driving wheel more often (e.g., at least once in a threshold time period, such as five second, 30 seconds, 1 minute, etc.). By changing the required user attentiveness, the driver may be required to look ahead more often (e.g., at least once in a threshold time period, such as five second, 30 seconds, 1 minute, etc.). By changing the autonomous driving level, one or more video contents may not be displayed on a display of the vehicle.

Hereinafter, examples of the present disclosure will be described with reference to the accompanying drawings.

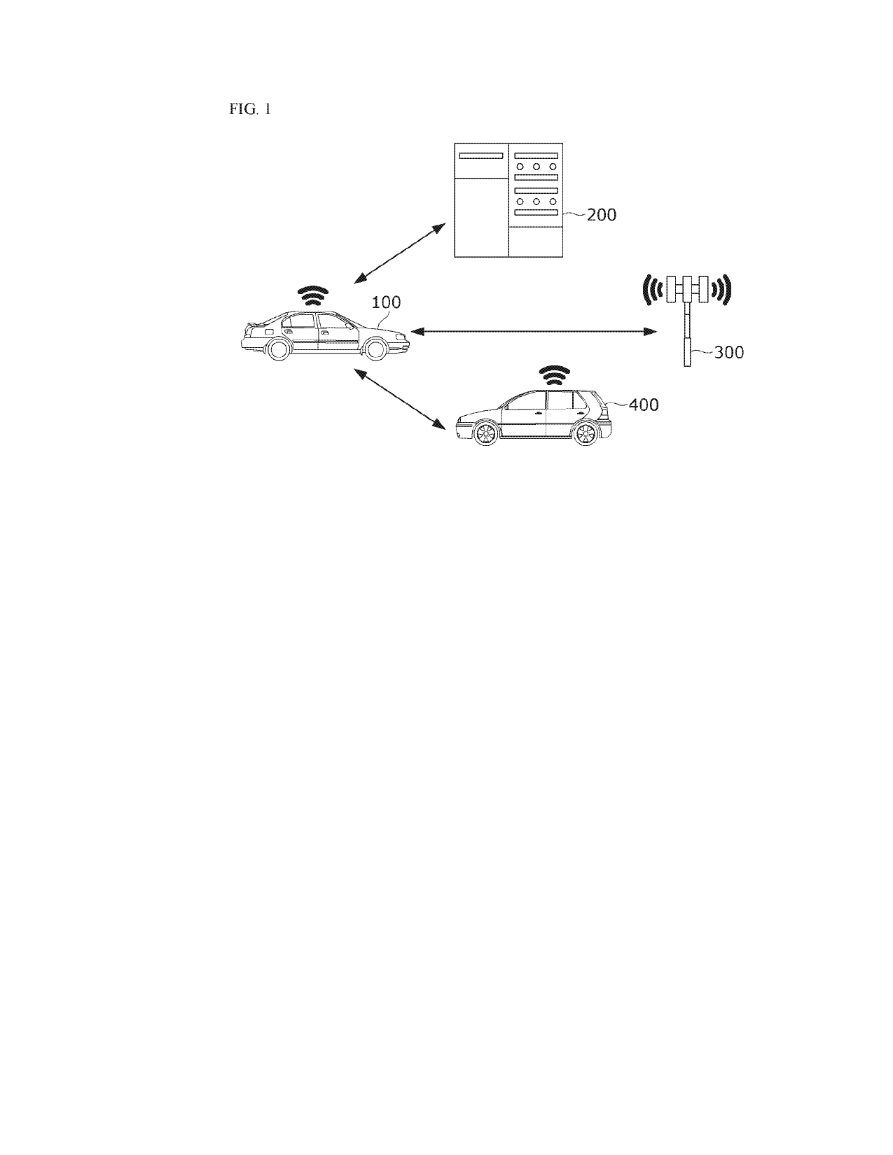

Hereinafter, a device used to acquire training data for an inference model will be described with reference to FIGS. 1 to 3. In the present disclosure, an example in which a vehicle 100 collects data that may be used as training data from among data acquired from a surrounding environment of the vehicle by its own sensor will be described. In addition, in the present disclosure, an example in which the vehicle 100 establishes an inference model through initial training or updates the inference model through re-training, and then transmits data to a server 200 that distributes the inference model to the vehicle 100 will mainly be described.

FIG. 1 is a diagram illustrating a vehicle communicating with another device to transmit and receive data.

Referring to FIG. 1, the vehicle 100 may be driven by electric energy and/or fossil fuel. In the case of the electric energy, the vehicle 100 may be, for example, a pure battery-based vehicle driven only by a high-voltage battery or a gas-based fuel cell as an energy source. In addition, the fuel cell may utilize various forms of gas that may generate electric energy, and the gas may be filled into the vehicle 100 in a liquefied state, for example. Here, the gas may be, for example, hydrogen. However, the present disclosure is not limited thereto, and various gases may be applied. In the case of the fossil fuel, the vehicle 100 may be driven by fuel such as gasoline, diesel, or liquefied gas, and may be equipped with an internal combustion engine that drives an actuating unit 116 by combustion of the fuel. The engine may be included in a power source unit 114 from the perspective of providing a driving rotational force of wheels to a wheel driving unit 118. As another example, the vehicle 100 may selectively utilize energy from a fossil fuel-based internal combustion engine and an electric battery to drive the actuating unit 116, which may be a hybrid-type vehicle.

The vehicle 100 may be a movable device. The vehicle 100 may be a ground vehicle that drives on the ground, and may be a typical passenger or commercial vehicle, a purpose built vehicle (PBV), etc. The vehicle 100 may be a four-wheeled vehicle, such as a passenger car, an SUV, and/or a small truck, and/or may be a vehicle with more than four wheels, such as a bus, a large truck, a container transport vehicle, a heavy equipment vehicle, etc. The vehicle 100 may be a robot in a broad sense, such as a transportation means, and the robot may be moved using wheels, tracks, or other movement modules.

The vehicle 100 may be controlled and driven by autonomous driving, and autonomous driving may be implemented as semi-autonomous driving or fully autonomous driving. The fully autonomous driving may be provided as autonomous movement in which the processor 120 of the vehicle 100 completely controls the operation without user intervention, even in uncertain driving situations. The semi-autonomous driving may be provided as autonomous movement that requires driver intervention in some specific driving situations. The semi-autonomous driving may be implemented such that the processor 120 deactivates autonomous driving upon the occurrence of the above situations and transfers control to a user, thereby enabling the user to perform manual driving. According to the level of the autonomous driving defined by the Society of Automotive Engineers (SAE), the semi-autonomous driving may correspond to autonomous driving levels 1 to 4, and the fully autonomous driving corresponds to level 5.

The vehicle 100 may communicate with other devices 200 and 300 or other vehicles 400. Other devices may include, for example, a server 200 that supports various controls, state management, and driving of the vehicle 100, an intelligent transportation system (ITS) device 300 for receiving information from the ITS, various types of user devices, etc. The server 200 may be, for example, an external device that is operated by a vehicle manufacturer and/or provided to service the autonomous driving, and may receive connectivity data of the vehicle 100 and/or transmit data required for the autonomous driving. In order to support the autonomous driving and various services of the vehicle 100, the server 200 may transmit various types of information and software modules used for controlling the vehicle 100 to the vehicle 100 in response to requests and data transmitted from the vehicle 100 and the user device.

The ITS device 300 may be, for example, a road side base station (RSU), and the ITS device 300 may exchange vehicle recognition data, driving control and state data, environmental data around the vehicle, map data, etc., with the vehicle 100 through vehicle-to-infrastructure (V2I) to assist the user with driving or support the autonomous driving of the vehicle 100. The vehicle 100 may exchange the data listed above with another vehicle 400 through vehicle-to-vehicle (V2V) to support the manual driving or the autonomous driving.

The vehicle 100 may communicate with another vehicle or another device based on cellular communication, wireless access in vehicular environment (WAVE) communication, dedicated short range communication (DSRC), short-range communication, and/or another communication method.

For example, the vehicle 100 may use a cellular communication network such as Long Term Evolution (LTE), 5th generation (5G), wireless fidelity (WiFi), and/or WAVE for communication with the server 200, the ITS device 300, and other vehicles 400. As another example, the DSRC, etc., used in the vehicle 100 may be used for communication between vehicles. The communication method among the vehicle 100, the server 200, the ITS device 300, other vehicles 400, and the user devices is not limited to the above-described example.

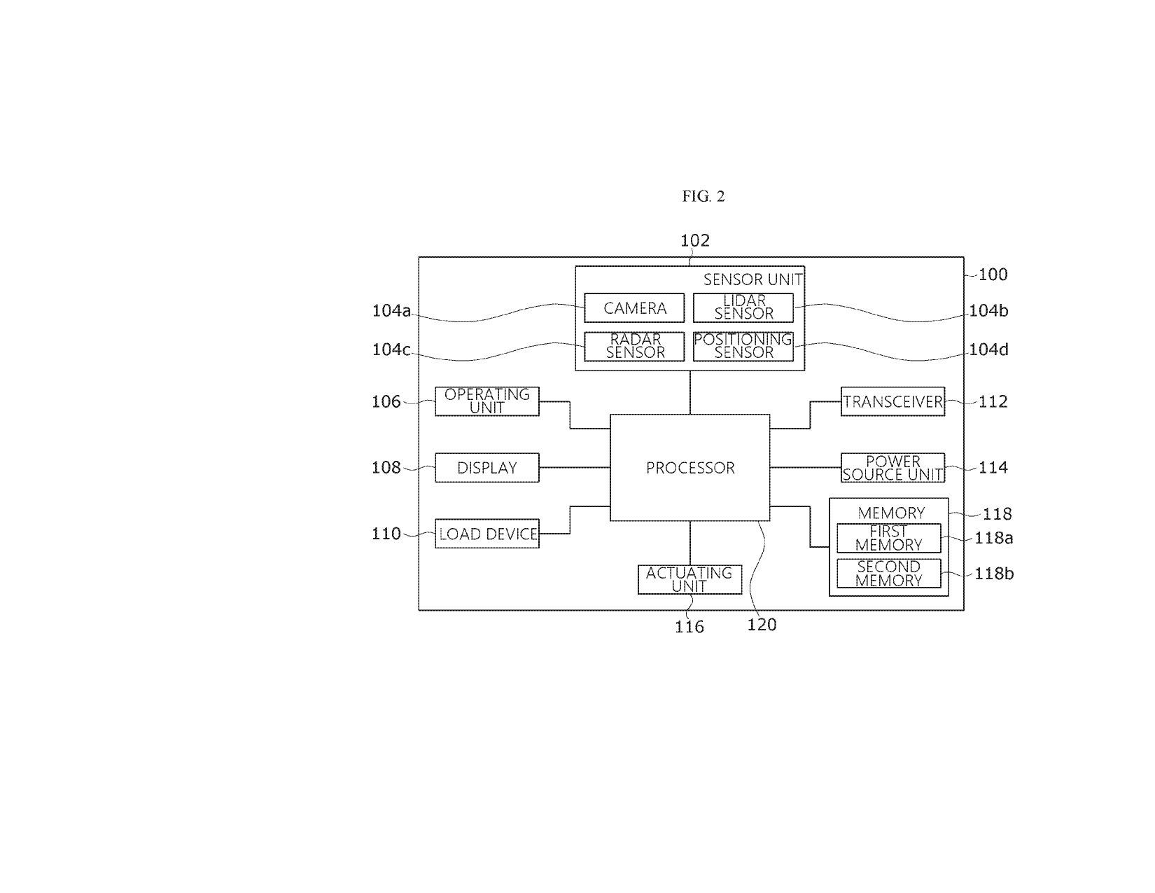

FIG. 2 is a diagram illustrating a module constituting a vehicle according to an example of the present disclosure.

The vehicle 100 may include a sensor unit 102, an operating unit 106, a display 108, a load device 110, and/or a transceiver 112.

The sensor unit 102 may be equipped with various types of detectors to detect various states and situations occurring in an external environment, an internal system, a user operation, and a boarding space of the vehicle 100.

Specifically, the sensor unit 102 may be equipped with an outward-facing camera 104a, a light detection and ranging (LiDAR) sensor 104b, a radar sensor 104c, etc., to recognize dynamic and static objects around the vehicle 100. The camera 104a may recognize an external object as an image during use of the vehicle 100 to generate image data and transmit the image data to the processor 120. The LiDAR sensor 104b may generate point cloud data as recognized data of an external object and transmit the generated point cloud data to the processor 120 to generate three-dimensional spatial information that identifies at least the shape of the external object. The radar sensor 104c may emit radio waves of a specific frequency around the vehicle 100 to detect the presence of external objects and their relative distances, speeds, directions, etc., and generate radar data through the radio waves reflected from the external objects. In the present disclosure, the LiDAR sensor 104b is provided as an example, but in other examples, the LiDAR sensor 104b may not be mounted.

In addition, the sensor unit 102 may include a positioning sensor 104d for confirming the position of the vehicle 100. The positioning sensor 104d is, for example, a Global Positioning System (GPS) sensor and/or a global navigation satellite system (GNSS) sensor, but is not limited thereto.

In addition, although not illustrated in FIG. 1, the sensor unit 102 may include a brake sensor, a wheel sensor, and a posture sensor. The brake sensor detects a braking degree of a brake, and the wheel sensor may detect, for example, a wheel speed, a wheel rotation angle, and a wheel rotation angular velocity of a wheel. The posture sensor may detect, for example, a three-axis state of the vehicle 100, for example, yaw, pitch, and roll, and output various vehicle posture states based on the above-described parameters. The posture sensor may be composed of, for example, an inertial measurement unit (IMU) sensor, a gyro sensor, etc. In the present disclosure, the sensors of the sensor unit 102 referenced in the description of the example are mainly described, and sensors that detect various situations not listed therein may be additionally included.

The operating unit 106 may be configured as a module for a user to control driving. For example, the operating unit 106 may be a steering wheel for manual driving, an automatic or manual transmission actuator, an accelerator pedal, a brake pedal, a gear shift, etc. The operating unit 106 may further be provided with an interface for the use, release, and selection of detailed functions of the autonomous driving mode requested by the user so that the user may use the autonomous driving function. The operating unit 106 may be configured as, for example, a hard type interface provided at a predetermined location inside the vehicle 100, and/or a soft type interface that may be touched on the display 108 in order to receive various requests related to the autonomous driving.

The display 108 may function as a user interface. The display 108 may display an operation state, a control state, route/traffic information, remaining energy information, content requested by a driver of the vehicle 100, etc., output by the processor 120. In addition, the display 108 may be configured as a touch screen capable of detecting driver input, and the display 108 may receive a driver’s request as an instruction for the processor 120.

The load device 110 may be mounted in the vehicle 100, and may be a type of non-driving electric device excluding a driving power system such as the wheel driving unit 118. The load device 114 may be an auxiliary device that receives power from the power source unit 114, and may be, for example, an air conditioning system, a lighting system, a seat system, and any of various devices installed in the vehicle 100.

The transceiver 112 may support mutual communication with the server 200, the ITS device 300, a nearby vehicle 300, etc. The transceiver 112 may include a module that processes, for example, cellular communication, WAVE, DSRC, etc. The transceiver 116 may transmit data generated or stored during driving to the server 200, and receive data and software modules transmitted from the server 200. The transceiver 116 may also support communication with an electronic device carried by a passenger inside the vehicle 100. The vehicle 100 may transmit and receive data utilized in the method according to the present disclosure to and from the outside through the transceiver 116.

In addition, the vehicle 100 may include the power source unit 114 and the actuating unit 116.

The power source unit 114 may generate and supply driving power and electric power used in the driving power system and the non-driving power system, such as the actuating unit 118. The non-driving power system may be, for example, the sensor unit 102, the operating unit 106, the display 108, the load device 110, and the transceiver 112, but is not limited thereto, and may include various components that implement sensing, interface, communication, and convenience functions, excluding components directly involved in the driving operation.

If the vehicle 100 is driven with electric energy, the power source unit 114 may be composed of, for example, an electric battery that is charged from the outside, or a combination of the electric battery and a fuel cell that charges the battery. In the case of the combination of the electric battery and the fuel cell, the power source unit 114 may include a tank that stores a material used to produce power for the fuel cell, for example, liquefied hydrogen. If the vehicle 100 is driven with fossil energy, the power source unit 114 may be composed of an internal combustion engine. In addition, if the vehicle 100 is a hybrid type, the power source unit 114 may be provided as a combination of an internal combustion engine and an electric battery.

The actuating unit 116 may have at least one module that implements a driving operation, and may perform at least one driving operation among longitudinal control such as acceleration/deceleration, lateral control such as steering, and gear shifting according to a user request from the operating unit 106 or a request from the processor 120. Here, the gear shifting may be processed by a manual driving user using a gear transmission or by a request from the processor 120 in the autonomous driving.

The actuating unit 116 may include a wheel driving unit (not illustrated), a mechanical component for implementing the driving operation in the wheel driving unit, and an electronic module for executing the driving operation according to a command of the processor 120 from the user’s manual operation or the autonomous driving. If the vehicle 100 is operated with electric energy, the vehicle 100 may include an assembly for transmitting the requested driving operation to the wheel driving unit 118. If the vehicle 100 is operated with fossil energy, the actuating unit 116 may include a transmission and a gear module that transmit the power of the internal combustion engine.

The wheel driving unit may include a plurality of wheels, a driving force generation module for generating and applying driving force to the wheels or transmitting the driving force, a braking module for decelerating the driving of the wheels, and a steering module for realizing the lateral control of the wheels. If the vehicle 100 is driven with electric energy, the driving force generation module may be configured as a motor assembly that generates driving force based on the power output from the electric battery. The braking module of the electric-based vehicle 100 may further have a regenerative braking function.

In addition, the vehicle 100 may include a memory 118 and the processor 120.

The memory 118 may store an application and various data for controlling the vehicle 100, and may load the application or read and record the data at the request of the processor 120. The memory 118 may store the application and at least one instruction for acquiring the training data for the inference model. The application may, for example, acquire the image data selected as the training data from among the image data around the vehicle acquired by a camera 104a, and transmit the image data to a server 200.

The inference model may be executed based on the image data, and the data transmitted as the training data may be image data. The present disclosure is not limited thereto, and point cloud data of a LiDAR sensor 104b and radar data of a radar sensor 104c may be selected as the training data. In this case, the inference model may output an inference result based on at least one of the point cloud data or the radar data. As another example, if the inference model uses the sensor data of at least one of the point cloud data and the radar data together with the image data, the image data and the sensor data may be selected as the training data.

In addition, the memory 120 may embed the inference model configured as an artificial intelligence network to support the driving function of the vehicle 100. The driving function may be, for example, an autonomous driving function. The inference model may be a training-based network that supports or controls driving in various situations. The inference model may be a network that identifies objects around the vehicle 100 from the sensor data, such as the image data, acquired from the vehicle 100, and supports prediction of behavior of the vehicle 100 due to the surrounding objects. The inference model may be a network related to, for example, object detection, semantic segmentation, depth information, synthetic images of a specific point in time such as bird’s-eye images, and end-to-end autonomous driving. The inference model is not limited thereto, and may be any of various training models for driving support.

The memory 118 may include a first memory 118a that temporarily stores data and a second memory 118b that continuously (or permanently) stores data. The first memory 118a and the second memory 118b may be provided as separate memory modules, for example. The first memory 118a and the second memory 118b may be, for example, a volatile memory (or RAM) and a nonvolatile memory (or ROM), respectively. As another example, the first memory 118a and the second memory 118b may be allocated to different areas of the same memory module and distinguished from each other.

The vehicle 100 may receive the inference model established by the training data from the server 200 and store the received inference model in the memory 118, and may be controlled by the inference model. In order to improve the function of the inference model, the vehicle 100 may receive update information of the model distributed from the server 200, for example, update information on trainable parameters of the model, and update the inference model managed in the memory 118 using the update information.

The processor 120 may perform the overall control of the vehicle 100. The processor 120 may be configured to execute applications and instructions stored in the memory 120. The processor 120 may generate control instructions for components of the vehicle 100 according to driving control requests in manual driving and autonomous driving. The components may be at least one of various members described in FIG. 2. In addition, the processor 120 may control driving and operation according to various situations in the corresponding components using the inference model.

The processor 120 may perform various processing operations related to acquiring the training data for the inference model. Details related to the processing operations described above will be described later.

The processor 120 is illustrated as a single processing module as a component, as in FIG. 2, to execute the processing described above. Specifically, the processor 120 may be equipped with an ECU that performs at least some of the processing operations described above. In another example, the processor 120 may be configured with multiple processing modules, and the processing operations may be distributed and processed in multiple modules.

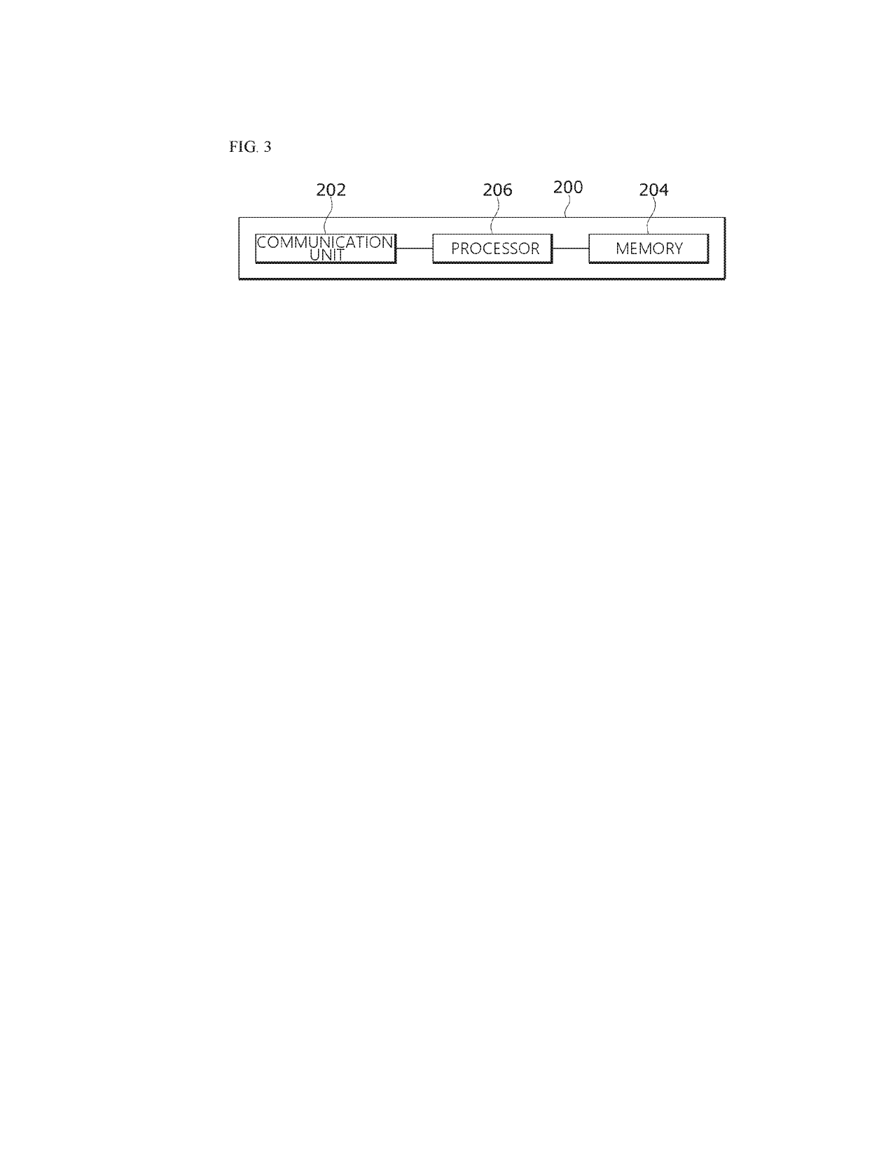

FIG. 3 is a diagram illustrating a module constituting a server according to the present disclosure.

The external device that receives the training data may be, for example, the server 200 that communicates with the vehicle 100. The server 200 may train or update the inference model based on the training data including at least image data received from the vehicle 100, and transmit the model or the update information of the model to the vehicle 100.

The server 200 may include a communication unit 202, a memory 204, and a processor 206.

The communication unit 202 may transmit and receive data to and from the external device, support mutual communication with the vehicle 100 in the present disclosure, and/or exchange data with the vehicle 100.

The memory 204 may store applications and various data for operating the server 200, and load the applications or read and record the data at the request of the processor 206. In the present disclosure, the memory 204 may manage the inference model embedded in the vehicle 100. If the inference model is the artificial intelligence network, the memory 204 may hold parameters of the model and store the update information resulting from the re-training of the model.

The processor 206 may perform the overall control of the server 200. The server 200 may be configured to execute the applications and instructions stored in the memory 204. The processor 206 may execute the applications, and process and respond to the user’s request transmitted from the vehicle 100. The processor 206 may train or update the inference model by analyzing the training data including at least image data received from the vehicle 100, and transmit the model or the update information of the model to the vehicle 100.

The processor 206 may be, for example, composed of a single processing module. As another example, the processor 206 may be distributed into multiple processing modules, and the above-described processing may be executed by the distributed processing model.

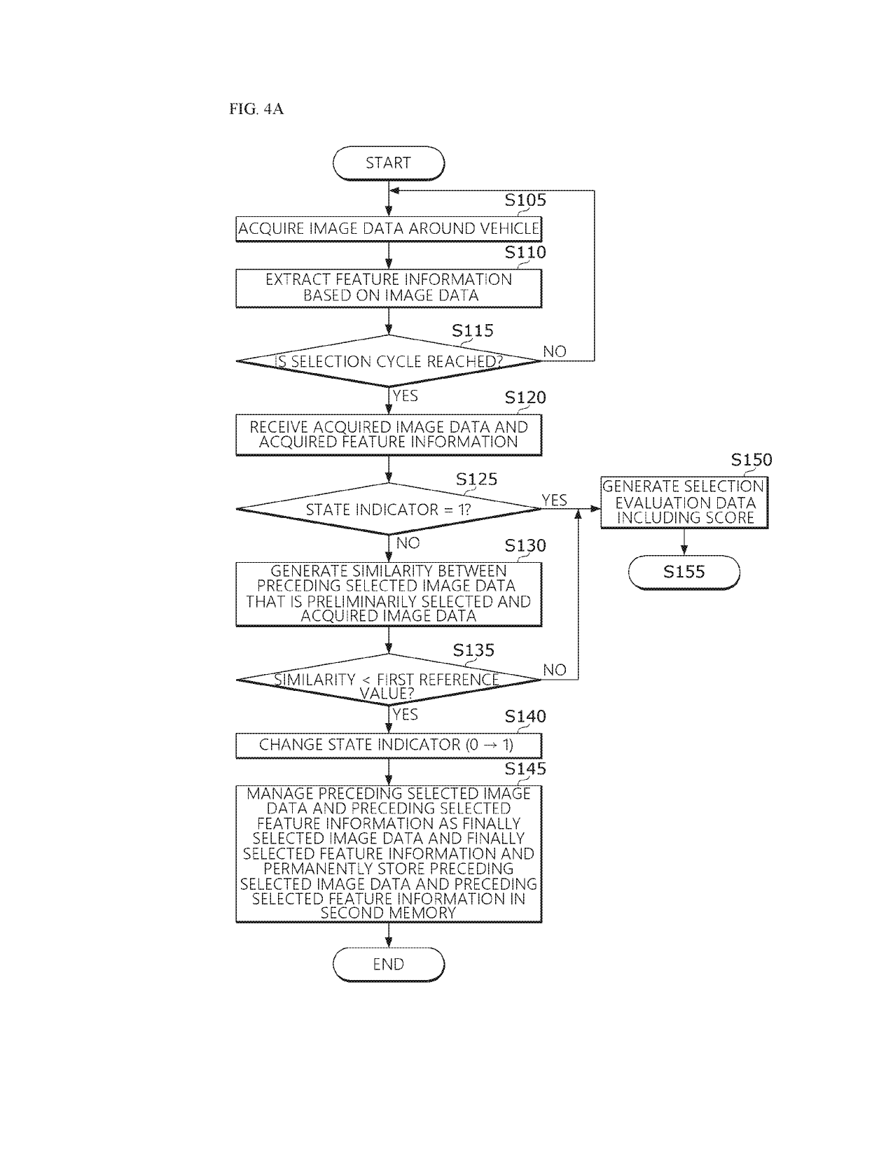

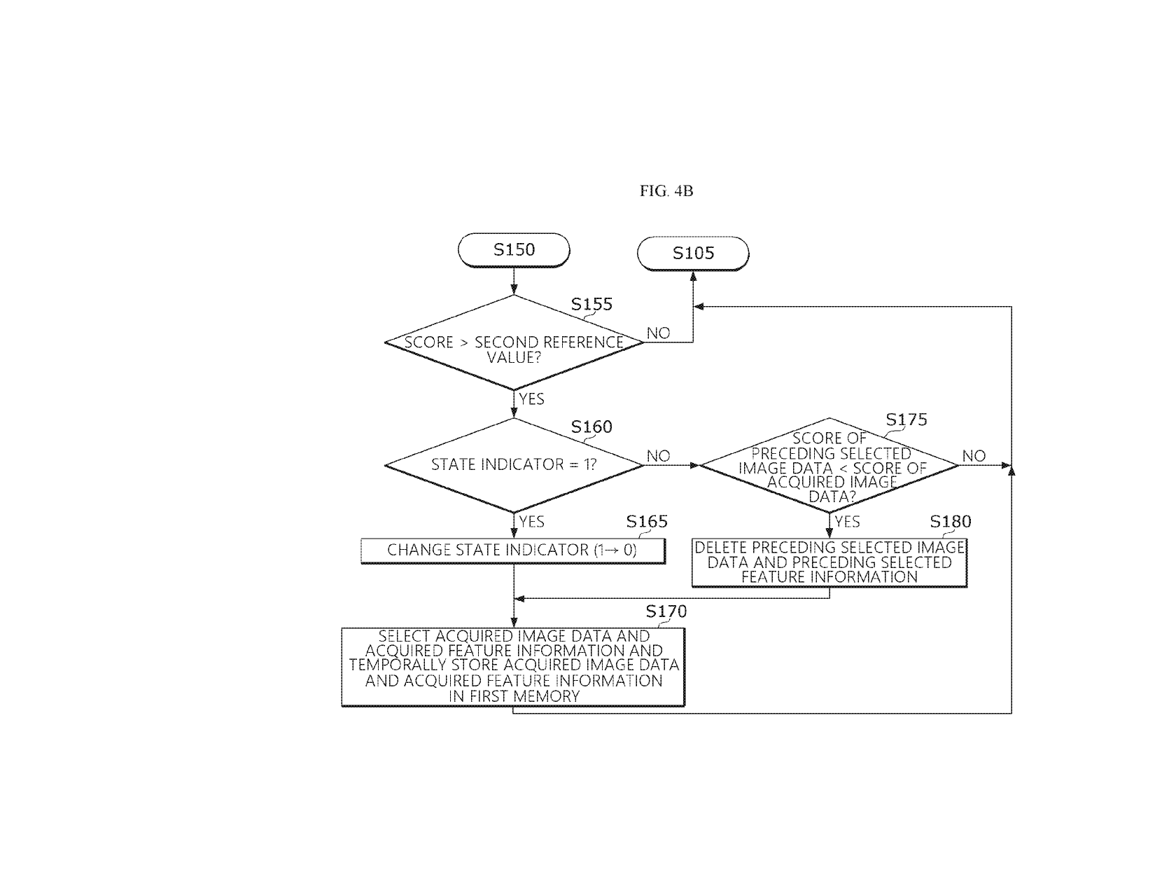

The acquisition processing of the training data performed in the vehicle 100 will be described in detail with reference to FIGS. 4A to 7. The following description is based on an example in which the vehicle 100 acquires the training data from the image data around the vehicle and transmits the acquired training data to the server 200. The acquisition and transmission of the training data is not limited to being performed by the vehicle 100, and may be implemented in various devices that collect the training data. In the present disclosure, the training data is described as the image data. However, the present disclosure may also be applied to an example in which the sensor data detecting the surrounding environment, for example, the point cloud data or the radar data, is selected as the training data and transmitted. In addition, the processor 120 that performs the method according to the example of the present disclosure may be described interchangeably with the vehicle 100 for convenience of description.

FIGS. 4A and 4B are flowcharts of a method for acquiring training data of an inference model according to another example of the present disclosure.

First, the processor 120 of the vehicle 100 may acquire the image data around the vehicle using the camera 104a (S105). The image data may be acquired at predetermined time intervals, and may be acquired to include, for example, scenes of the predetermined number of frames per unit time.

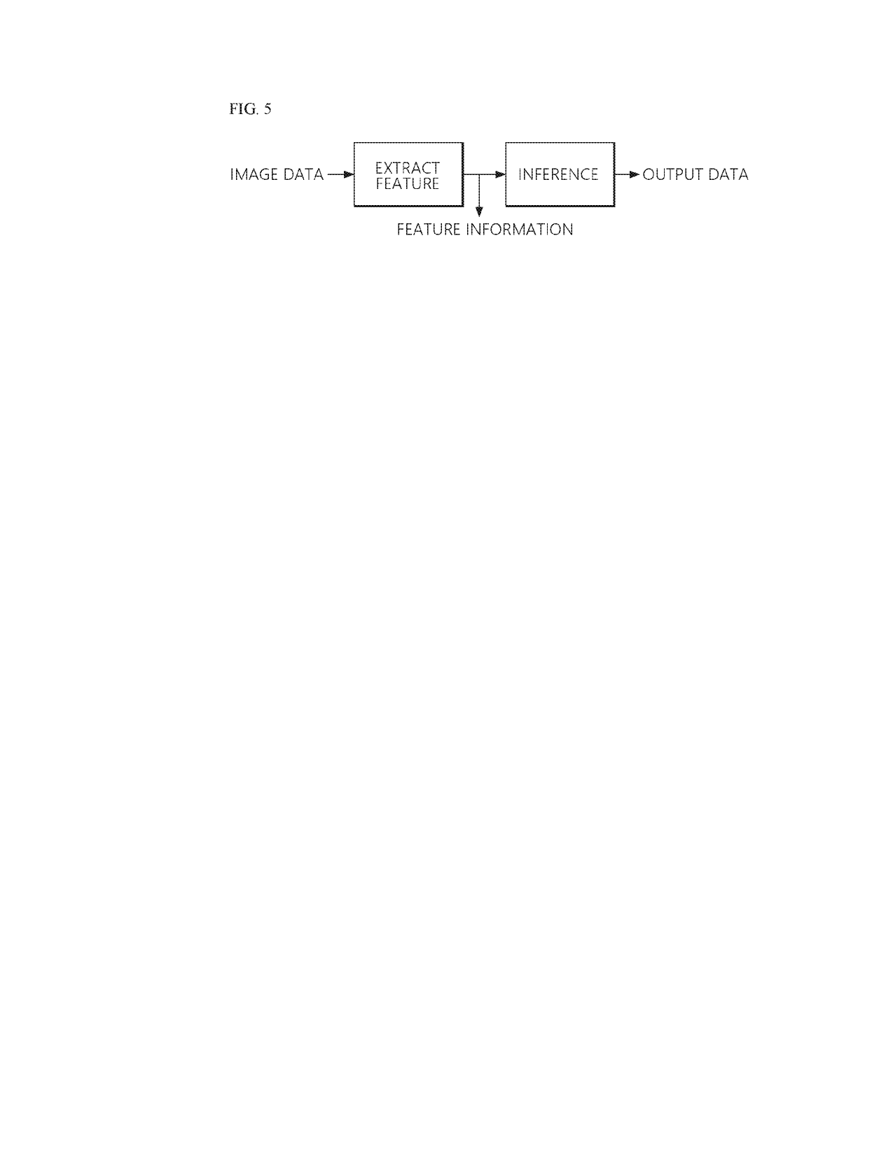

The processor 120 may extract features from the image data to generate feature information (S110). The vehicle 100 may, for example, have the inference model embedded therein. As illustrated in FIG. 5, the inference model may extract features from the image data to generate feature information, and generate a predetermined inference result provided by the model based on the feature information as output data. FIG. 5 is a diagram illustrating a training-based inference model. The generation of the feature information is processed by, for example, an encoder, and the inference result may be processed by a decoder related to classification, prediction, or analysis provided by the model.

When the inference model uses the image data, a function module related to feature extraction may be included in the inference model. The feature extraction of the image data may be processed by, for example, using an encoder including a multi-layer convolutional layer and a filter, but is not limited thereto and may be performed in various ways.

The feature information may include at least one of abstracted image data and additional information. The abstracted data may be, for example, vector data of abstracted image features. The additional information may be entropy data related to the inference uncertainty probability of the image data generated from the inference model. The entropy data may be a prediction error probability distribution for the inference result in the output data. As the value of the entropy data increases, the inference uncertainty probability increases, and accordingly, the prediction error probability of the inference result may increase.

As another example, the vehicle 100 need not have the inference model embedded therein. The vehicle 100 may have a function module that mainly extracts the feature information in order to provide data for training the inference model in the server 200.

Referring to FIG. 4A, the processor 120 may determine whether the selection cycle has been reached (S115), and based on the arrival of the selection cycle, receive the image data and feature information corresponding to the selection cycle as the acquired image data and the acquired feature information, respectively (S120).

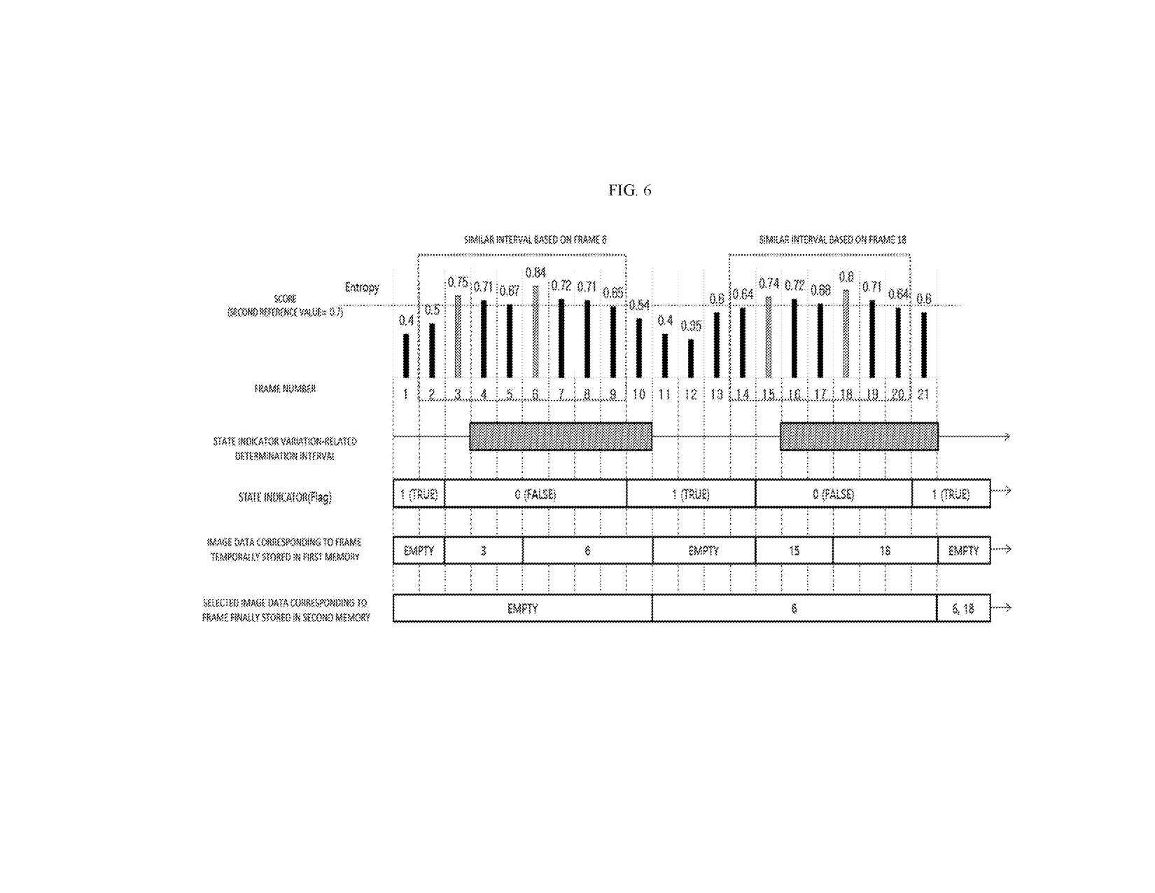

The selection cycle may be a collection cycle of the image data to be evaluated as the training data among the image data. The selection cycle may be set to be greater than the time interval related to the acquisition of the image data in operation S105. The selection cycle may be once per multiple frames, for example, once per 30 frames. As illustrated in FIG. 6, the acquired image data related to each numbered frame may be image data acquired from the camera 104a according to the selection cycle among multiple image data. FIG. 6 is a diagram illustrating a process of acquiring training data.

The processor 120 may identify a state indicator stored in the memory 118 and confirm the state described in the state indicator (S125).

The state indicator may indicate whether there is a similarity between the preceding selected image data and the previously acquired image data subsequent to the selected image data.

The preceding selected image data may be preliminarily selected and temporally stored, or may be continuously (or permanently) stored and managed as the finally selected image data. The previously acquired image data may be the acquired image data subsequent to the selected image data and immediately precedes the currently acquired image data in operation S120.

In relation to the preliminary selected image data, the preceding selected image data may be the acquired image data that is preliminarily selected as a candidate for training data among the acquired image data acquired earlier than the currently acquired image data. The preceding preliminary selected image data may be temporarily stored and managed in the first memory 118a. The preceding preliminary selected image data may be the acquired image data selected in operation S170 of FIG. 4B during a process related to the evaluation and selection of the acquired image data.

According to the example of FIG. 6, when the currently acquired image data is frame 4 to frame 6, the preceding preliminary selected image data may be acquired image data of frame 3. In this example, when the currently acquired image data is frame 6, the previously acquired image data is acquired image data of the frame immediately before frame 6, i.e., frame 5.

According to the example of FIG. 6, when the currently acquired image data is frame 7 to frame 10, the preceding preliminary selected image data may be acquired image data of frame 6. According to the example of FIG. 6, when the currently acquired image data is frame 16 to frame 18, the preceding preliminary selected image data may be acquired image data of frame 15. According to the example of FIG. 6, when the currently acquired image data is frame 19 to frame 21, the preceding preliminary selected image data may be acquired image data of frame 18. In these examples, the previously acquired image data may be acquired image data corresponding to a frame immediately before the currently acquired image data, as described above.

In relation to the finally selected image data, the preceding selected image data may be the acquired image data finally selected as the training data among the acquired image data acquired earlier than the currently acquired image data. The preceding finally selected image data may be continuously stored and managed in the second memory 118b. The preceding preliminary selected image data may be the acquired image data selected in operation S145 of FIG. 4B during a process related to the evaluation and selection of the acquired image data.

According to the example of FIG. 6, when the currently acquired image data is frame 11 to frame 15, the preceding preliminary selected image data may be the acquired image data of frame 6. In this example, when the currently acquired image data is frame 13, the previously acquired image data is acquired image data of the frame immediately before frame 13, i.e., frame 12.

In the state indicator, the presence or absence of the similarity may be determined by the similarity based on the selected feature information and the acquired feature information of each of the preceding selected image data and the previously acquired image data. The selected feature information and the acquired feature information may be, for example, vector data of the preceding selected image data and vector data of the previously acquired image data. If the similarity between the vector data is, for example, greater than or equal to a first reference value, the state indicator may be described as a flag indicating the presence of the similarity. Here, a reference value of operation S135 described below may be used as the first reference value.

The flag for the presence of the similarity may be 0 (FALSE), as illustrated in FIG. 6. When the flag of the state indicator is FALSE, the state indicator may indicate a state in which no valid visual environment change has occurred in the scene of the acquired image data immediately before the currently acquired image data, compared to the scene of the last selected image data. The state indicator may indicate that the image data immediately before acquired is in a similar situation to the last selected image data. If the state indicator indicates the presence of the similarity, the last selected image data may be the preceding preliminary selected image data. As illustrated in FIG. 6, when frame 10 is the currently acquired image data and a state indicator related to frame 9 is FALSE, the last selected image data may be the preceding preliminary selected image data corresponding to frame 6, and may be temporarily stored in the first memory 118a.

If the similarity between the vector data is, for example, greater than or equal to the first reference value, the state indicator may be described as a flag indicating the absence of the similarity. The flag for the absence of the similarity may be 1 (TRUE), as illustrated in FIG. 6. When the flag of the state indicator is TRUE, the state indicator may indicate a state in which the valid visual environment change has occurred in the scene of the acquired image data immediately before the currently acquired image data, compared to the scene of the last selected image data. When the state indicator indicates the absence of the similarity, the last selected image data may be the preceding finally selected image data. As illustrated in FIG. 6, when frame 11 is the currently acquired image data and a state indicator related to frame 10 is TRUE, the last selected image data may be the preceding finally selected image data corresponding to frame 6, and may be permanently stored in the second memory 118b.

Referring back to FIG. 4A, if there is a similarity in the state indicator, the processor 120 of the vehicle 100 may generate the similarity between the preceding selected image data that was preliminarily selected and the currently acquired image data (S130).

The state indicator indicating the presence of the similarity may be expressed as a flag described as FALSE (0), as illustrated in FIG. 6. The preliminarily selected image data applied in operation S130 may be data that has been preliminarily selected and temporarily stored in the first memory 118a. As illustrated in FIG. 6, when the currently acquired image data is image data corresponding to frame 10, the preliminarily selected image data may be the preceding preliminarily selected image data corresponding to frame 6. The image data described above may be an input for generating the similarity.

The processor 120 may, based on the presence of the similarity in the state indicator, generate the similarity by the selected feature information and the acquired feature information of each of the preliminarily selected preceding selected image data and the acquired image data.

The selected feature information and the acquired feature information may be, for example, vector data of each piece of image data, and the similarity may be a vector similarity according to vector data of each piece of the preceding preliminarily selected image data and the acquired image data. The similarity need not be limited to the above-described matters and may be generated in various ways.

The processor 120 may determine whether the similarity between the preceding preliminarily selected image data and the currently acquired image data is less than the first reference value (S135).

Based on determining that the similarity is less than the first reference value, the processor 120 may change the state indicator to indicate the absence of the similarity (S140).

As illustrated in FIG. 6, when the acquired image data is frame 10, the preceding preliminarily selected image data is frame 6, and the similarity is less than the first reference value, the state indicator may be changed from the presence of the similarity (FALSE; 0) to the absence of the similarity (TRUE; 1).

Thereafter, the processor 120 may determine the preliminarily selected preceding selected image data as the finally selected image data and continuously store the finally selected image data in the second memory 118b, and determine the preceding selected feature information related to the preceding selected image data as the finally selected feature information and permanently store the finally selected feature information in the second memory 118b (S145).

As illustrated in FIG. 6, in relation to the acquired image data corresponding to frame 10, when the state indicator is changed to the absence of the similarity, the acquired image data and acquired feature information related to preceding example frame 6 may be determined as the finally selected image data and the finally selected feature information. The finally selected image data and the finally selected feature information of the frame 6 may be utilized as the preceding selected image data and the preceding selected feature information in the selection processing (operations S125 to S180) of the acquired image data acquired subsequently.

Referring back to FIG. 4A, when the state indicator is identified as the absence of the similarity (TRUE; 1) in operation S125 or the similarity is greater than or equal to the first reference value in operation S135, the processor 120 may generate the selection evaluation data including the score of the acquired image data according to the evaluation using the acquired feature information of the currently acquired image data (S150). In other words, the processor 120 may generate the selection evaluation data related to the acquired image data according to the evaluation based on the state indicator being identified as the absence of the similarity (TRUE; 1) or the similarity being greater than or equal to the first reference value.

The acquired feature information may include the data generated in operation S110 and may include, for example, at least one of the entropy data and the vector data related to the currently acquired image data. In FIG. 6, the selection evaluation data may be, for example, the entropy data, and the entropy data may be generated with a score of 1 or less. In the case of the vector data, the selection evaluation data may be generated by analyzing the vector data included in each of the preceding selected image data and the acquired image data. In the present disclosure, the selection evaluation data is mainly described as being generated as the entropy data.

According to the example of FIG. 6, when the acquired image data is frame 3, the state indicator is the absence of the similarity (TRUE; 1) according to frame 2 immediately before frame 3 in operation S125. In the examples related to operations S160, S165, and S170 described below, the acquired image data used when the state indicator is identified as the absence of the similarity may be the image data of frame 3.

According to the example of FIG. 6, when the acquired image data is frame 6, the state indicator is the presence of the similarity (FALSE; 0) according to frame 5 immediately before frame 6 in operation S125, and the similarity of the image data related to frames 5 and 6 in operation S135 is greater than or equal to the first reference value. In the example related to operations S160, S175, and S180 described below, the acquired image data used when the state indicator is identified as the presence of the similarity and the similarity is greater than or equal to the first reference value may be the image data of frame 6.

Thereafter, the processor 120 of the vehicle 100 may determine whether the score of the acquired image data exceeds the second reference value (S155).

As illustrated in FIG. 6, when the selection evaluation data related to the score is the entropy data, the second reference value may be predetermined entropy data. In FIG. 6, it is shown, as an example, that the entropy of the second reference value is 0.7, and the acquired image data exceeding the second reference value is frames 3 and 6. As the score of the acquired image data becomes greater than the second reference value, the uncertainty inference probability of the acquired image data may increase.

Based on the score exceeding the second reference value, the processor 120 may re-identify the state indicator of the currently acquired image data (S160).

The identification of the state indicator related to the currently acquired image data may confirm either the absence of the similarity (FALSE; 0) identified in operation S125 or the presence of the similarity (FALSE; 0) identified for the execution of operation S135.

According to the example of FIG. 6, when the acquired image data is frame 3, the state indicator may be identified as the absence of the similarity (TRUE; 1) according to operation S125. When the acquired image data is frame 6, the state indicator may be identified as the presence of the similarity (FALSE; 0) according to operations S125 and S135.

If the state indicator is identified as the absence of the similarity, the processor 120 may change the state indicator to the presence of the similarity (S165). According to the example of FIG. 6, the state indicator corresponding to the acquired image data of frame 3 may be changed to the presence of the similarity (FALSE; 0).

Thereafter, the processor 120 may preliminarily select the currently acquired image data and the currently acquired feature information as the selected image data and the acquired feature information and temporarily store the selected image data and the acquired feature information in the first memory 118a (S170). According to the example of FIG. 6, the acquired image data and the acquired feature information of the frame 3 may be temporarily stored in the first memory 118a as the preliminary selected image data and the preliminary selected feature information. The selected image data and the selected feature information of the frame 3 may be utilized as the preceding selected image data and the preceding selected feature information in the selection processing (operations S125 to S180) of the acquired image data acquired subsequently.

Based on the state indicator having the score exceeding the second reference value in operation S155 and the presence of the similarity in operation S160, the processor 120 may determine whether the score of the currently acquired image data exceeds the score of the preceding selected image data (S175).

According to the example of FIG. 6, the acquired image data of the frame 6 may be image data corresponding to the state indicator having the similarity exceeding the first reference value, the score exceeding the second reference value, and the presence of the similarity along the route of S125, S135, and S150 to S160. Here, the preceding selected image data may be the acquired image data of the frame 3 that is temporarily stored in the first memory 118a and is preliminarily selected. The score may be related to the selection evaluation data described in operation S150.

Based on the score of the acquired image data exceeding the score of the preceding selected image data, the processor 120 may select the currently acquired image data and the currently acquired feature information as the selected image data and the selected feature information, and the preceding selected image data and cause the preceding selected feature information to be deleted so that the preceding selected image data and the preceding selected feature information may be replaced with the data and the information (S180).

According to the example of FIG. 6, the acquired image data of the frame 6 has the score greater than the selected image data of the frame 3 that was preliminarily selected, and therefore the acquired image data and the acquired feature information of the frame 6 may be the preliminarily selected image data and the preliminarily selected feature information that replace the frame 3. Accordingly, the selected image data and the selected feature information of the frame 3 temporarily stored in the first memory 118a may be deleted.

Thereafter, the processor 120 may temporarily store the currently acquired image data and the currently acquired feature information, which are preliminarily selected as the selected image data and the selected feature information, respectively, in the first memory 118a instead of the deleted preceding selected image data and the deleted preceding selected feature information.

The selected image data and the selected feature information of the frame 6 may be utilized as the preceding selected image data and the preceding selected feature information in the selection processing (operations S125 to S180) of the acquired image data acquired subsequently.

When the score of the acquired image data in operation S155 is lower than or equal to the second reference value or the score of the acquired image data in operation S175 is lower than or equal to the score of the preceding selected image data, the processor 120 may proceed to operation S105 and perform the processing related to operations S120 to S180 on the subsequently acquired image data and acquired feature information acquired according to the selection cycle. According to the example of FIG. 6, since the acquired image data of the frame 9 has a score lower than or equal to the second reference value, the acquired image data of the frame 10 is received, and operations S120 to S180 may be processed for the frame 10. Since the acquired image data of the frame 7 has a score lower than or equal to the selected image data of the frame 6, the acquired image data of the frame 8 may be received, and operations S120 to S180 may be processed for the frame 8.

To summarize the process of acquiring the training data of the inference model according to FIGS. 4A and 4B with the example of FIG. 6, among the acquired image data of the frames 2 to 9 having a similarity greater than or equal to the first reference value, the frame 3 may be preliminarily selected as the selected image data when the score of the selection evaluation data exceeds the second reference value. Among the acquired image data subsequent to the frame 3, the frame 6 is similar to the frame 3 with a similarity greater than the first reference value, but exceeds the score of the frame 3, and thus may be selected as the finally selected image data and permanently stored to replace the frame 3.

The acquired image data and acquired feature information of the frame 6 may be stored in the second memory 118b as the finally selected image data and the finally selected feature information, and may be transmitted to the external device, such as the server 200. In the example of FIG. 6, the acquired image data and the acquisition information of the frame 18 selected as the finally selected image data are also stored in the second memory 118b through the same selection process as the frame 6, and may be transmitted to the external device.

The collection of the redundant data having the same or a similar situation is prevented, and data having a vulnerable scene with a high uncertainty inference probability may be selected. Accordingly, by selectively storing the valid data among the consecutive similar data and transmitting the stored valid data to the external device, the data collection efficiency, and the memory and the transmission resource efficiency may be significantly improved.

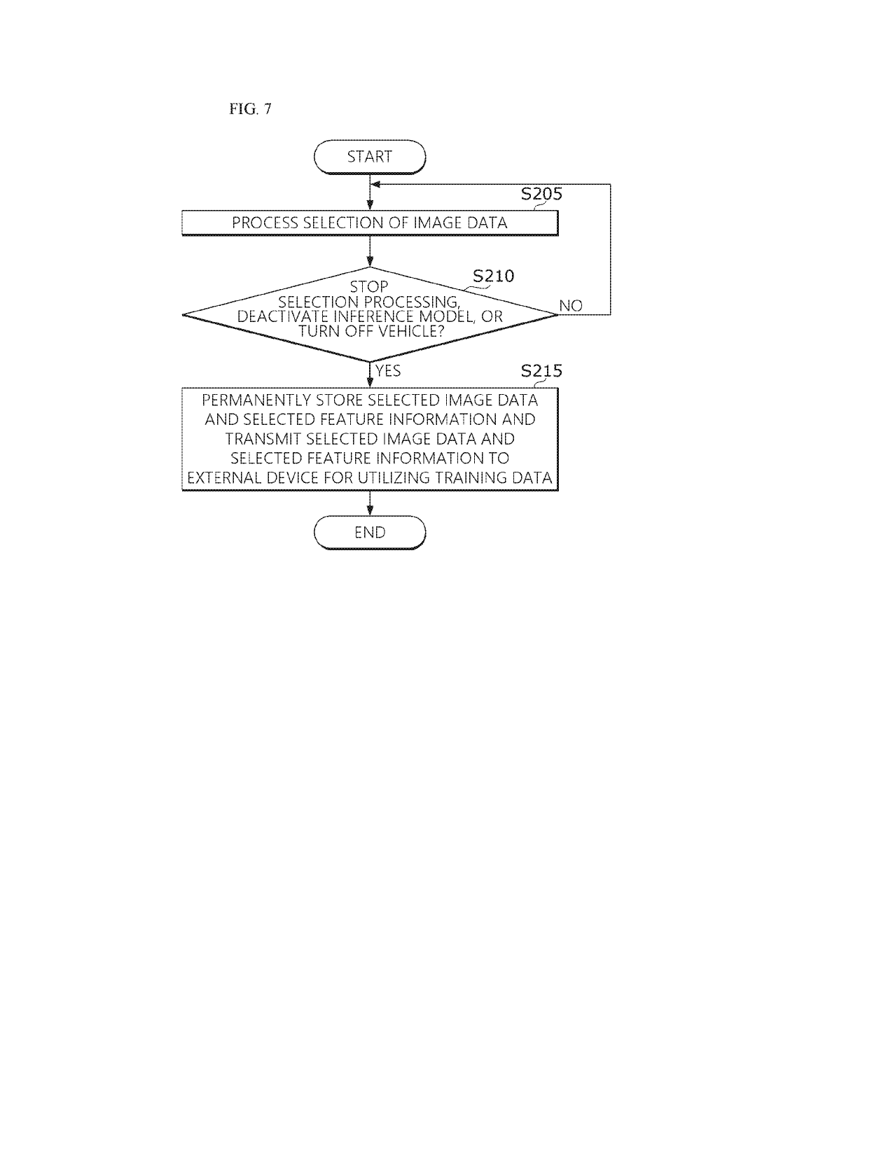

FIG. 7 is a flowchart illustrating a process of terminating selection of image data and transmitting the image data in the method for acquiring training data of an inference model according to an example of the present disclosure.

The processor 120 of the vehicle 100 may perform the selection processing of the image data along with the method for acquiring training data according to FIGS. 4A and 4B (S205).

The processor 120 may determine whether at least one termination event among the deactivation of the inference model, the selection processing of the image data, or the operation off of the device has occurred (S210). The device may be the vehicle 100, and the operation off may be, for example, turning off the vehicle 100.

If the termination event occurs, the processor 120 may continuously store the acquired image data and the acquired feature information determined as the finally selected image data and the finally selected feature information in the second memory 118b and transmit the finally selected image data and the finally selected feature information to the external device, such as the server 200 (S215). According to the example of FIG. 6, the acquired image data and the acquired feature information of the frames 6 and 18 may be permanently stored in the second memory 118b as the finally selected image data and the finally selected feature information and transmitted to the server 200. The server 200 may train or update the inference model using the selected image data and the finally selected feature information and distribute the inference model to the vehicle 100. The trained or updated inference model may control the vehicle 100 for driving and various operations.

By preventing the collection of the redundant data and selecting the data that is valid for training the inference model, it is possible to acquire training data for an inference model for improving the acquisition efficiency of the high-quality training data.

Effects which can be achieved by the present disclosure are not limited to the above-described effects. That is, other objects that are not described may be obviously understood by those skilled in the art to which the present disclosure pertains from the following description.

While the illustrative methods of the present disclosure described above are represented as a series of operations for clarity of description, that description is not intended to limit the order in which the steps are performed, and the steps may be performed simultaneously or in different order as necessary. In order to implement the method according to the present disclosure, the described steps may further include other steps, may include remaining steps except for some of the steps, or may include other additional steps except for some of the steps.

The various examples of the present disclosure are not a list of all possible combinations and are intended to describe representative aspects of the present disclosure, and the matters described in the various examples may be applied independently or in combination of two or more.

In addition, various examples of the present disclosure may be implemented in hardware, firmware, software, or a combination thereof. In the case of implementing the present invention by hardware, the present disclosure can be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

The scope of the disclosure includes software or machine-executable commands (e.g., an operating system, an application, firmware, a program, etc.) for enabling operations according to the methods of various examples to be executed on an apparatus or a computer, a non-transitory computer-readable medium having such software or commands stored thereon and executable on the apparatus or the computer.

What is claimed is:

1. A method of acquiring training data for an inference model, the method comprising:
identifying, based on acquisition of image data around a device according to a selection cycle, a state indicator indicating whether there is a similarity between preceding selected image data and acquired image data subsequent to the preceding selected image data;
generating, based on presence of a similarity in the state indicator, a value indicating a similarity between the preceding selected image data and the acquired image data;
generating, based on determining that the value indicating a similarity is greater than or equal to a first reference value, selected evaluation data including a score of the acquired image data according to an evaluation using acquired feature information of the acquired image data;
selecting, based on determining that the score of the acquired image data exceeds the score of the preceding selected image data, the acquired image data as selected image data for the training data to replace the preceding selected image data; and
outputting the selected acquired image data.

2. The method of claim 1, wherein the acquired feature information includes at least one of:
entropy data related to an inference uncertainty probability of the acquired image data generated by the inference model, or
vector data resulting from a computational abstraction of the acquired image data.

3. The method of claim 1, wherein one of:
the preceding selected image data is preliminarily selected and temporarily stored, or
the preceding selected image data is continuously stored and managed as finally selected image data.

4. The method of claim 1, further comprising:
prior to the selecting of the acquired image data, determining whether the score of the acquired image data exceeds a second reference value, wherein the selecting of the acquired image data is performed in response to the score of the acquired image data exceeding the second reference value.

5. The method of claim 1, further comprising:
after the identifying of the state indicator:
generating, based on absence of the similarity in the state indicator, the selected evaluation data including the score of the acquired image data according to the evaluation;
changing, based on the score of the selected evaluation data exceeding a second reference value, the state indicator so that the state indicator indicates presence of the similarity; and
selecting the acquired image data as the selected image data.

6. The method of claim 5, wherein the selected acquired image data is preliminarily adopted as the selected image data and temporarily stored.

7. The method of claim 1, further comprising:
after the generating of the similarity:
changing, based on determining that the value indicating a similarity is less than the first reference value, the state indicator to indicate absence of the similarity;
determining the preceding selected image data as finally selected image data; and
continuously storing the determined preceding selected image data.

8. The method of claim 1, further comprising:
after the selecting of the acquired image data, transmitting the acquired image data, determined as finally selected image data, to an external device.

9. The method of claim 8, wherein the transmitting of the acquired image data to the external device is performed in response to at least one termination event of:
deactivation of the inference model,
selection processing of the acquired image data, or
a non-operational state of the device, wherein the acquired image data is continuously stored in response to the termination event, and wherein the device embeds the inference model.

10. The method of claim 1, further comprising:
after the generating of the selected evaluation data:
generating, based on acquisition of subsequently acquired image data according to the selection cycle, and based on determining that the score of the acquired image data is lower than or equal to the score of the preceding selected image data, selected evaluation data including the score of the acquired image data according to the evaluation;
determining whether the score of the subsequently acquired image data exceeds the score of the preceding selected image data; and
determining, based on the determining whether the score of the subsequently acquired image data exceeds the score of the preceding selected image data, whether to select the subsequently acquired image data as the selected image data to replace the preceding selected image data.

11. A device for acquiring training data for an inference model, the device comprising:
a sensor unit configured to detect a surrounding environment;
a transceiver configured to transmit and receiving data to and from an external device;
a memory configured to store at least one instruction; and
at least one processor configured to execute the at least one instruction stored in the memory, wherein the at least one instruction, when executed by the at least one processor, cause the device to:
identify, based on acquisition of image data around the device from the sensor unit according to a selection cycle, a state indicator indicating whether there is a similarity between preceding selected image data and acquired image data subsequent to the preceding selected image data;
generate, based on presence of a similarity in the state indicator, a value indicating a similarity between the preceding selected image data and the acquired image data;
generate, based on determining that the value indicating a similarity is greater than or equal to a first reference value, selected evaluation data including a score of the acquired image data according to an evaluation using acquired feature information of the acquired image data;
select, based on determining that the score of the acquired image data exceeds the score of the preceding selected image data, the acquired image data as selected image data for the training data to replace the preceding selected image data; and
output the selected acquired image data.

12. The device of claim 11, wherein the acquired feature information includes at least one of:
entropy data related to an inference uncertainty probability of the acquired image data generated by the inference model, or
vector data resulting from a computational abstraction of the acquired image data.

13. The device of claim 11, wherein one of:
the preceding selected image data is preliminarily selected and temporarily stored in the memory, or
the preceding selected image data is continuously stored and managed in the memory as finally selected image data.

14. The device of claim 11, wherein, prior to selecting the acquired image data:
the device is further configured to determine whether the score of the acquired image data exceeds a second reference value, and
the selection of the acquired image data is performed in response to the score of the acquired image data exceeding the second reference value.

15. The device of claim 11, wherein, after identifying the state indicator, the device is further configured to:
generate, based on absence of the similarity in the state indicator, the selected evaluation data including the score of the acquired image data according to the evaluation,
determine whether the score of the acquired image data exceeds a second reference value,
change, based on determining that the score of the acquired image data exceeds the second reference value, the state indicator to indicate the presence of the similarity, and
select the acquired image data as the selected image data.

16. The device of claim 15, wherein the selected acquired image data is preliminarily adopted as the selected image data and temporarily stored in the memory.

17. The device of claim 11, wherein, after generating the similarity, the device is further configured to:
change, based on determining that the value indicating a similarity is less than the first reference value, the state indicator to indicate absence of the similarity, and
determine the preceding selected image data as finally selected image data and continuously store the determined preceding selected image data in the memory.

18. The device of claim 11, wherein, after selecting the acquired image data, the device is further configured to transmit the acquired image data, determined as finally selected image data, to an external device.

19. The device of claim 18, wherein the device is configured to transmit the acquired image data to the external device in response to at least one termination event of:
deactivation of the inference model,
selection processing of the acquired image data, or
a non-operational state of an acquisition device of the training data, wherein the acquired image data is continuously stored in the memory in response to the termination event, and wherein the acquisition device of the training data embeds the inference model.

20. A computing device configured to preprocess image data for use in a machine learning model, the computing device comprising:
one or more processors; and
memory storing instructions that, when executed by the one or more processors, cause the computing device to:
receive, via one or more sensors on a vehicle, first image data depicting an environment around the vehicle at a first time;
processing the first image data to identify one or more features of the first image data;
calculate, based on the one or more features, and by comparing the one or more features to one or more second features of second image data depicting the environment around the vehicle at a second time, a similarity value indicating a similarity between the first image data and the second image data;
generate, based on the similarity value, a score;
generate, based on the score, training data comprising one or more of:
at least a portion of the first image data; and
at least a portion of the second image data; and
cause training of the machine learning model using the training data.
